(19) United States
(12) Patent Application Publication
(10) Pub. No.: US 2004/0205706 A1
(43) Pub. Date: Oct. 14, 2004

(54) Method for the automatic generation of computer programs which interact with existing objects

(76) Inventor: Michael T. Portwood, Zachary, LA (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 09/681,761

(22) Filed: May 31, 2001

(51) Int. Cl. G06F 9/44

(52) U.S. Cl. 717/113; 717/162; 717/109

(57) ABSTRACT

A method for developing an application for interacting with one or more external objects where a Workbench program receives the initial instructions from the software developer and queries the external objects which are to interact with the application to obtain sufficient information to interact with the external objects. A Built Project is produced by the Workbench which contains a series of instructions for a Runtime program to produce an application which interacts with the external objects. The Runtime takes the Built Project and using a runtime environment such as the JRE, builds the desired application. The purpose of the Runtime is to reproduce the user interface that was designed using the Workbench and connect that user interface to the specified external objects. Once it performs this function, the Runtime's job is done. The end user only directly interacts with the Built Project and the resulting application, not the Workbench nor the Runtime.

### BACKGROUND OF INVENTION

The present invention relates generally to a system and method for creating and executing application programs and other software and, particularly, to a system for automating the task of developing application programs which interact with existing objects.

Today, complex, mission critical software has become the rule both in the business and scientific communities. Typically, such programs require communication between one or more objects, such as existing software, in the same or other computers connected in a network. As an end result, sophisticated end-user interfaces, complex reporting capabilities, computation intensive software components and software integration across platforms have become the rule. Such sophistication, in turn, requires sophistication in the maintenance and modification of such software. Software developers, by necessity, must be able to write programming code for multiple platforms; communicate between diverse software programs and objects; and develop interfaces and systems for their integration in a single user interface. When one takes into account that computers in this context mean a broad array of intelligent devices including Internet appliances, cellular phones, hand held organizers and for that matter, household appliances and automobiles, the difficulty of universal programming and integration becomes readily apparent.

As is all too familiar to anyone who uses such sophisticated systems, this collection of skills and abilities is both not readily available and, even when available, is no guarantee that their utilization will speedily result in the desired application. Typically, drafting thousands of lines of computer programming code is followed by extensive testing and correction. Historically structured programming has been the norm. That is, various functions are first defined and the program is designed to call such defined functions at appropriate times to effect the overall objective of the application program.

One approach in solving this problem has been to use “application generators.”These are programs which generate source programming code for application programs. Such tools are normally referred to as Rapid Application Development (RAD) tools such as Borland's AppExpert, and Microsoft's AppWizard. In such systems, the software developer provides the tool with initial input for indicating the type of application program desired. The software then uses these inputs to produce complex source programming code for a working program which includes the attributes specified by the user. It does this by using highly structured templates into which the software developer has indicated certain parameters. These slightly modified templates then have to be extensively altered by the software developer to accomplish the desired result. In other words, such programs build a skeleton from standard parts to which the software developer then adds the flesh to produce the desired end result.

In contrast to such software generating programs or the even earlier approach of simply writing the program from A to Z, the new paradigm is that of object oriented programming. An object is defined by its external interface and the software developer considers, and for that matter interacts, only with the external interface of the object. However, the software developer must still fully understand the interface in order to take full advantage of the object in its interaction with the program under development. Thus, the software developer must not only be familiar with the programming language and the program generating application, but with every object with which the desired end product will interact.

Where the desired program is to be used on several different platforms, the software developer's task may be multiplied by the use of multiple programming languages, programs and objects. Thus, while existing program building software relieves some of the task, the major programming tasks are still left to a software developer able to develop code in one or more programming languages and understand the action of assorted objects with which the program is to interact.

The resulting application normally resides on each client computer. It may interact with one or more objects which reside on that client computer or on another computer in a network with that client. Thus, the resulting application must contain the complete coding necessary to carry out its function and to interact with the other objects. If the program is a large one, the program not only requires substantial space on each computer where it resides, but each modification of the application may require substantial time for the original or new versions to be distributed through a network to each of the client computers.

What has been lacking, up to the present, is a computer program development tool which generates a working program from a mere indication of desired function, including automatically analyzing and integrating with any desired objects without the software developer having extensive knowledge as to the nature of the object interface, nor less the object programming. In other words a program that explores the objects with which it is to interact, not only eliminating the need to know the computer language and interface of the object but even the human language it displays in its screen. Equally lacking is a cross platform development tool which minimizes the size of the resulting application. In other words, what is inherently desirable, but missing from the existing systems, is a tool for automatically developing a working, cross-platform and cross-human language program of minimum size which automatically interacts with desired existing objects.

### SUMMARY OF INVENTION

The present invention goes beyond the present object-oriented approach by, in essence, automatically studying particular existing objects and automatically developing an appropriate interface to directly interact with the object or a subset of the object. The querying of the object or objects and structuring of the desired program is done by an editor or development tool (the “Workbench”) which would normally reside on the software developer's computer or be accessible by the software developer's computer through a network. The objects which it explores may reside on the software developer's computer, or elsewhere on an intranet or the Internet.

The Workbench produces a collection of data which delineates the attributes and parameters of the desired application (the “Project”). Through the Workbench's simple graphic interface, a software developer identifies the Project and indicates the external objects (i.e., objects that are defined and created outside of the Workbench) which are to interact with the program under development. The Workbench by querying the external object, i.e., by reflection, discovers the interface to each external object which will be incorporated into the Project and uses this information in the development of the Project. In other words, it learns the methods and fields of the external objects, and by automatically developing a description of them, develops a description of a functioning application (the “Default Project”).

After the Workbench interrogates the external object or objects, the Workbench may be used to refine the resulting Default Project. The software developer may add graphics, change colors, change fonts or other design aspects from that of the Default Project. The software developer may also use the Workbench to add sections of programming code for interaction with external objects. For example, the software developer could add an automatic calculation or a filter to alter an object or generate a new external object to the Project. Equally, the software developer may change the look and feel of the Default Project by such additional programming code. The additional programming code is in an appropriate cross-platform programming language such as Java. Use of the Java programming language to create extensions to elements of the Default Project broaden the capabilities of the resulting application in comparison to the cookie cutter approach of current RAD tools.

After development of the Default Project, and its editing and tweaking using the Workbench is completed, the software developer finalizes the Project, i.e., creates a “Built Project.” In finalization, the Workbench creates a compressed storage space to hold the Project, compiles all of the programming code that the software developer has specified during editing, loads the Project specification into memory, serializes the Project specification while removing Project attributes that only have value to the development process, and adds items such as graphic files and help files. If the resulting application is to run in the Sun Microsystems' Java Runtime Environment (JRE), the storage space would be in the in the form of a Java Archive file (JAR).

The information in the Project is used to build the desired application by an interpretive program (the “Runtime”) which is not specific to any one Project. The application produced by the Runtime operates independently of the Runtime, i.e., after generation of the application, the Runtime plays no part in the operation of the resulting application.

If the application is to run in the JRE, the runtime would also be written in Java programming language and would be stored as a JAR. It thus could take advantage of the JRE already residing on most computers. The Built Project would be stored as a separate JAR. The Built Project would be relatively compact. To distribute an application to an individual computer having access to the Runtime either locally or over a network requires only the JAR for the Built Project, since the JRE would already permanently reside on the user's computer. The advantages for distribution of programs over the Internet are obvious. The resulting programs are significantly smaller, faster, scalable and deployable not only as a standalone application but as web applets.

As can be seen from the above, to develop a Project, first the Workbench receives the initial instructions from the software developer and queries the external objects which are to interact with the developed program. The Built Project contains all of the instructions developed in the Workbench and the information specific to the Project as a series of instructions for the Runtime. The Runtime takes the Built Project and using a runtime environment such as the JRE, builds the desired application. The purpose of the Runtime is to reproduce the user interface that was designed using the Workbench and connect that user interface to the specified external objects. Once it performs this function, the Runtime's job is done. There is no direct interaction between the software developer and the Runtime. While the Workbench itself may be a Built Project, the Runtime is, in operation, independent of the Workbench, which however is a necessary part of the development of the Built Project. The end user only directly interacts with the Built Project and the resulting application, not the Workbench nor the Runtime.

Since the Runtime uses the JRE already residing on most computers today to supply much of the programming code to run the Built Project, even what would be very large programs when constructed by prior art methods can, by skilled use of the Workbench, be reduced in size by 80 or 90 percent.

### BRIEF DESCRIPTION OF DRAWINGS

FIG. 1 is a flow diagram of the overall process of generating a Project;

FIG. 2 is a flow diagram for automatically generating a Default Project;

FIG. 3 is the initial screen shot of the Workbench;

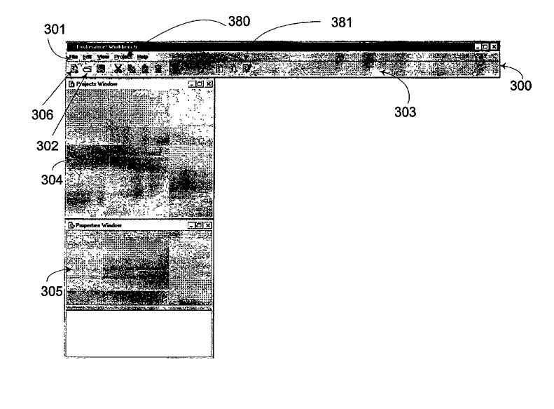

FIG. 4 is a screen shot of the Workbench with the product identity dialog box open;

FIG. 5 is a screen shot of the Workbench with the connection dialog box open;

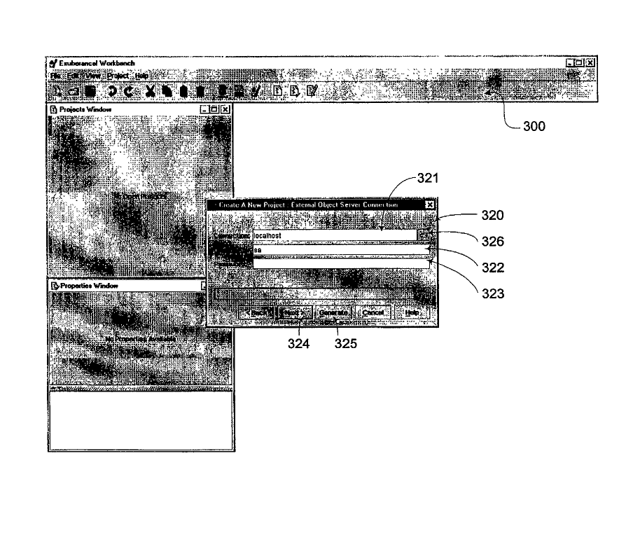

FIG. 6 is a screen shot of the Workbench with the component selection dialog box open;

FIG. 7 is a flow diagram of the information generation for external objects;

FIG. 8 is a schematic representation of a default project;

FIG. 9 is a screen shot of the Workbench with the project dialog box open;F

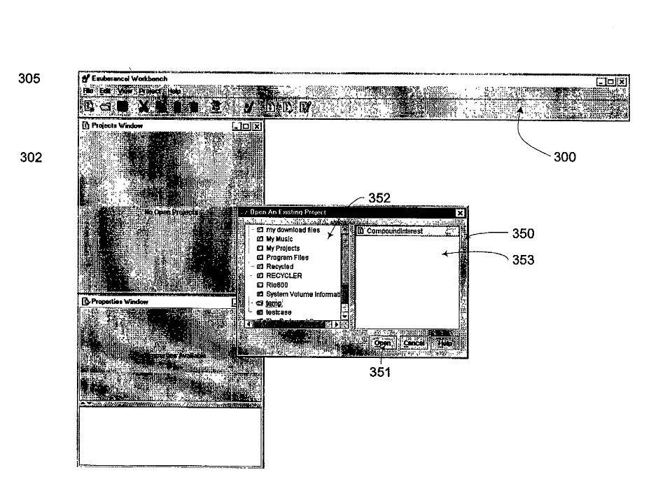

FIG. 10 is a screen shot of the Workbench with the project window open;

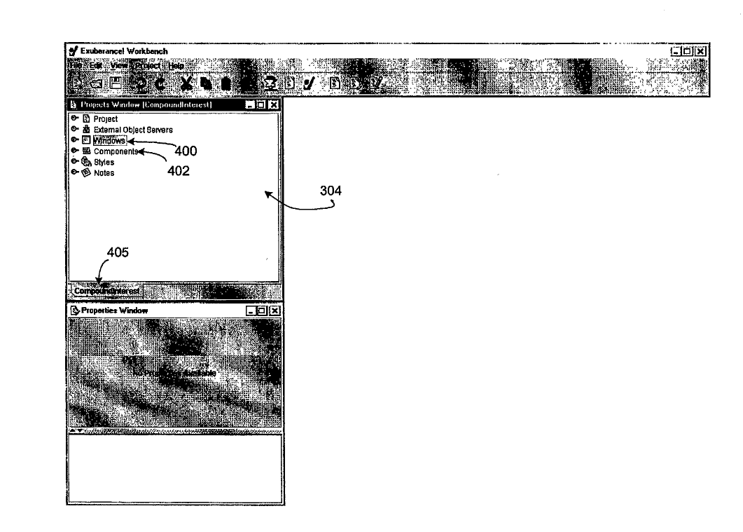

FIG. 11 is a screen shot of the Workbench with the new frame dialog box open;

FIG. 12 is a screen shot of the Workbench with the properties window open;

FIG. 13 is a screen shot of the Workbench with the new panel box open;

FIG. 14 is a screen shot of the Workbench with the panel folder expanded;F

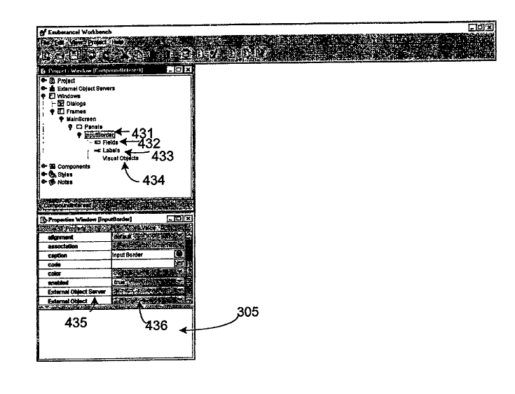

FIG. 15 is a screen shot of the Workbench with the properties information window open;F

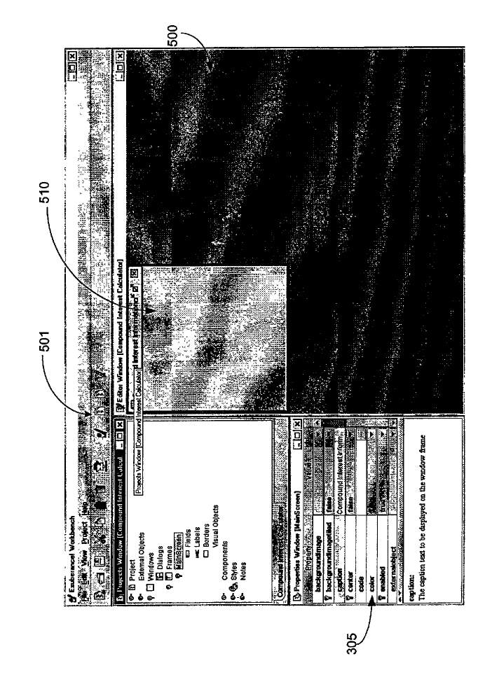

FIG. 16 is a screen shot of the Workbench with the label adding box open;

FIG. 17 is a screen shot of the Workbench with the editor window open;

FIG. 18 is a screen shot of the Workbench with the editor window for parameters open;

FIG. 19 is a screen shot of the Workbench with the visual object dialog box open;

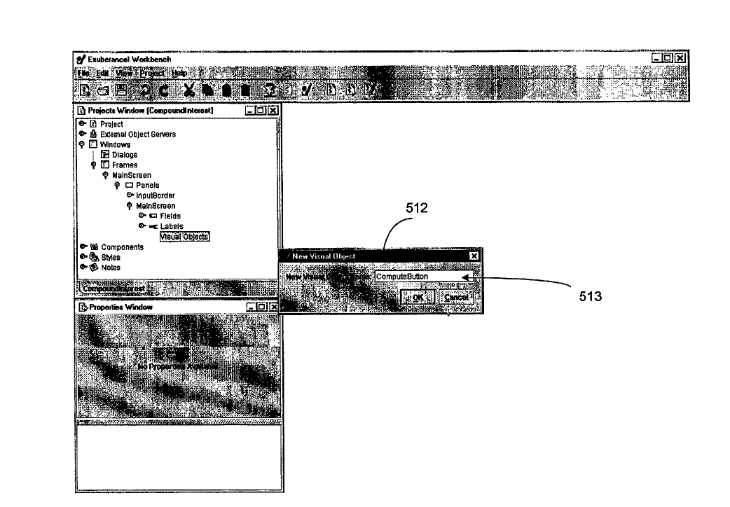

FIG. 20 is a screen shot of the Workbench with the editor window open and a new button being displayed;

FIG. 21 is a screen shot of the Workbench with the Java source window open;

FIG. 22 is a screen shot of the Workbench with the Java class window open;

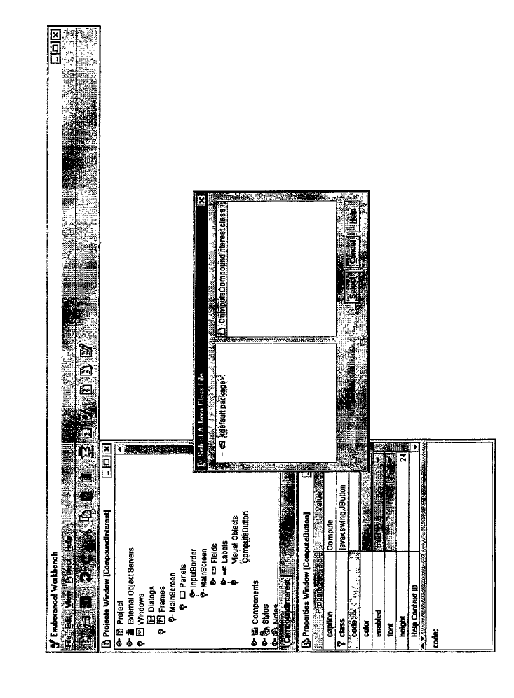

FIG. 23 is a printout of the project specification file;

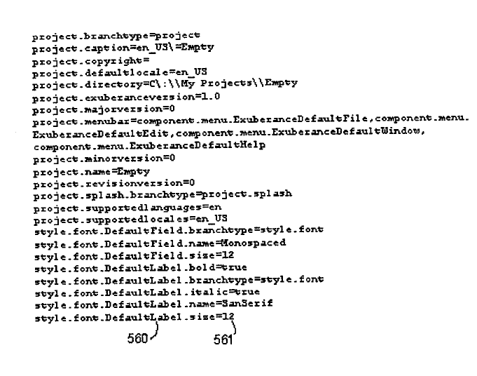

FIG. 24 is a screen shot of the Workbench with the build project dialog box open;

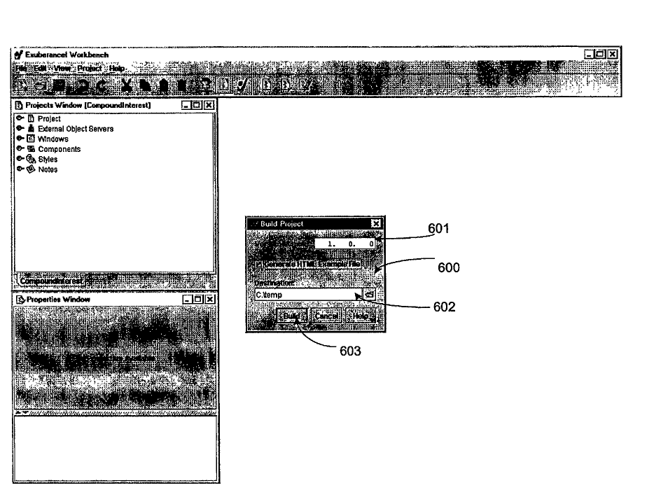

FIG. 25 is a schematic representation of a built project;

FIG. 26 is a schematic representation of a runtime;

FIG. 27 is a flow diagram of the reflection engine;

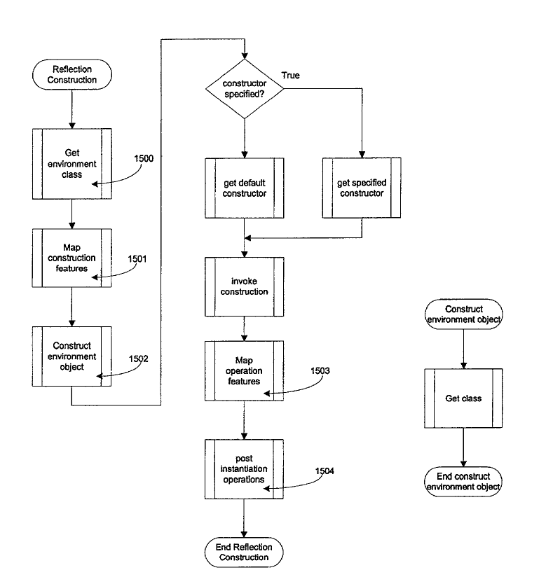

FIG. 28 is a flow diagram of the runtime;

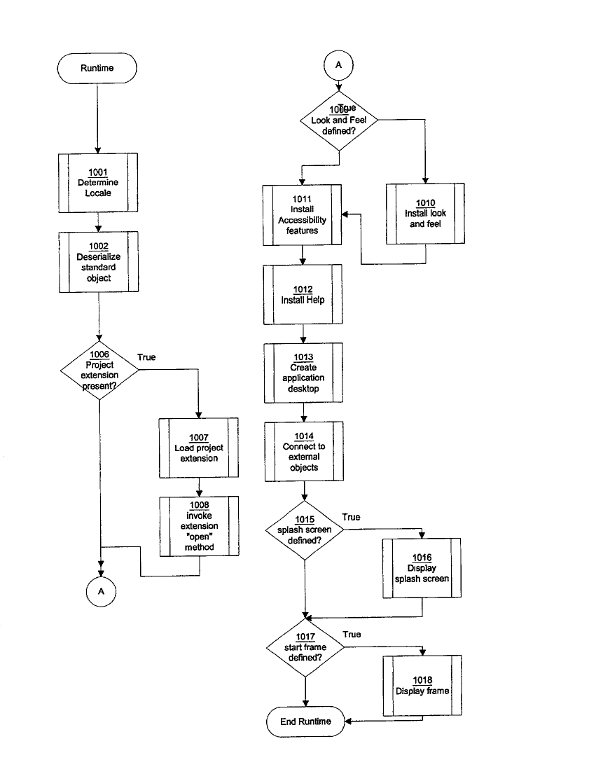

FIG. 29 is a schematic representation of the relationship between the Server and Client;

FIG. 30 is a schematic representation of the relationship between the Server and Client;

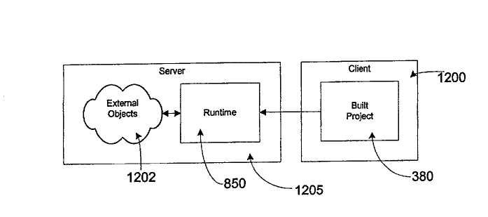

FIG. 31 is a schematic representation of the relationship between the Server and Client;

FIG. 32 is a schematic representation of the local device.

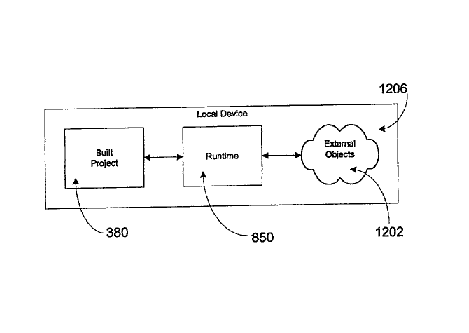

### DETAILED DESCRIPTION

The present invention involves two distinct phases. The first phase is the generation of a Project through the use of the Workbench. The Workbench first generates a Default Project based on information supplied by the software developer and, if it is to interact with external objects, identification of such external objects. The resulting Default Project is then edited and finalized by the Workbench to produce a Built Project which can then be distributed to end users for use in conjunction with the Runtime.

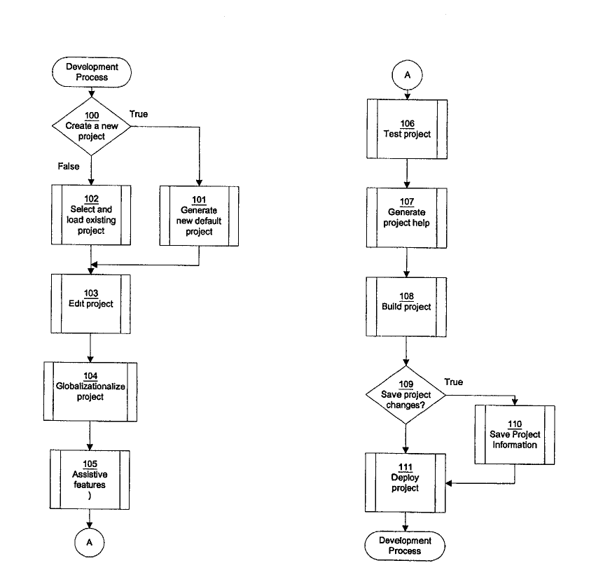

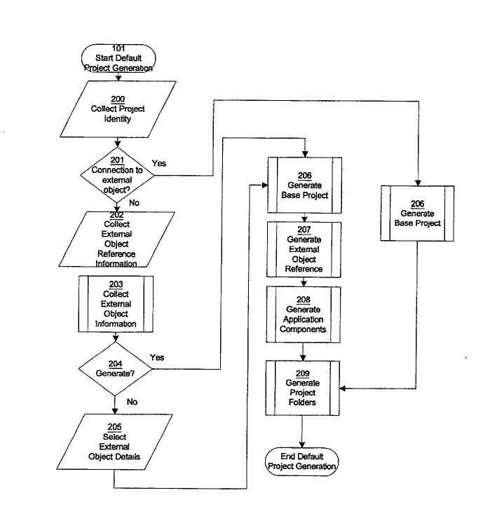

FIG. 1 discloses the overall process of Project generation, while FIG; 2 discloses the details of generating the Default Project which is later edited in the Workbench to complete a Project. In describing the process of Project generation by the Workbench, FIG. 1 and FIG. 2 will be used in conjunction with corresponding screen shots of the Workbench carrying out the steps of the flow diagrams of FIG. 1 and FIG. 2 in developing a Project for calculating compound interest based on an external object.

When the Workbench is opened an initial screen appears on the software developer's computer screen. It consists primarily of the Workbench menu bar and tool bar 303. Floating Projects Window 304 and Properties Window 305 are also displayed. If the software developer is starting a new Project, the software developer will start the Project generation process by so indicating in the file menu or by icon on tool bar that a new Project generation is to be initiated. This, in turn, initiates a wizard which will lead the software developer through the process of developing a Default Project The process for the generation of the Default Project is most clearly seen in FIG. 2.

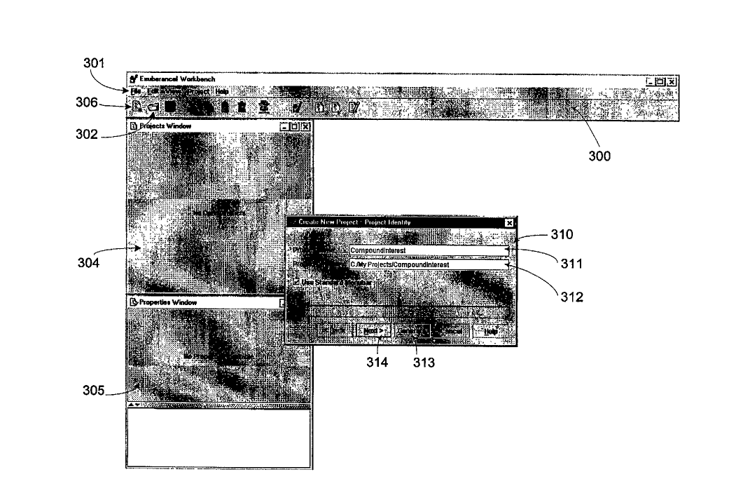

As seen in FIG. 4, upon initiation of a new Project wizard a Project Identity Dialog Box appears which provides text fields for the software developer to name the Project and to direct where the Project is to be stored In this example, the Project is named “CompoundInterest” and it is to be stored at “C:/My Projects/compoundinterest.” If the Project will not be interacting with an external object or the software developer wishes to define the external objects at a later time, the software developer indicates that a Default Base Project should be generated 206 by clicking on the “generate” button The Workbench then generates a formatted file called the Project Specification File. It is a list in a compressed text format of various information about the Project, including the Project name, as entered in text field of dialog box and information which have been previously supplied by the software developer to the Workbench about the standard or initial environment in which the software developer's Projects are to be run. Information such as the human language (English, German etc.), default color scheme, and time zone may be included.

If, however, the Project is to interact with one or more external objects the software developer would activate the “next” button on the Project Identity Dialog Box and an External Object Connection Server Dialog Box would be displayed as seen in Fig. The External Object Connection Server Dialog Box identifies the location where each external object, or group of external objects, to be referenced is located. External Object Connection Server Dialog Box has a Connection Text Field for entry of the location of one or more of the objects to be added to the Project. Any standard form of identification, such as a Universal Resource Identifier (“URI”), may be used. A button may be used to aid navigation of the available environment. External Object Connection Server Dialog Box also has text fields for the user name and password if needed. Where different user names and/or passwords are necessary for entry to two or more objects at the same location, each object must be entered separately with a more exact location indicated so that the user identification and password can be separately designated.

Protocols are established methods for communicating with external objects, i.e., established ways for interrogation and integration of external objects, including the Internet InterORB Protocol (“IIOP”), Lightweight Directory Access Protocol (“LDAP”), Remote Procedure Call (“RPC”), Remote Method Invocation (“RMI”), Java Database Connectivity (“JDBC”) and numerous others. The protocol is normally designated for each object by the platform's Naming and Directory Service. The Workbench learns about the object through introspection or reflection. First, the Workbench determines the protocol used to communicate with the external object. The software developer can specify identification of the object's protocol in text field 321 along with the location. For example, entry of iiop://localhostin text field would designate all objects on the client computer (localhost) at port 900 using the IIOP protocol. The port number is only required if the protocol is not located on the computer's default port. The designation localhost can be replaced with other identification means, such as its numeric equivalent. The external object reference information and the user name and password allow the Workbench to investigate the objects contained at the designated location.

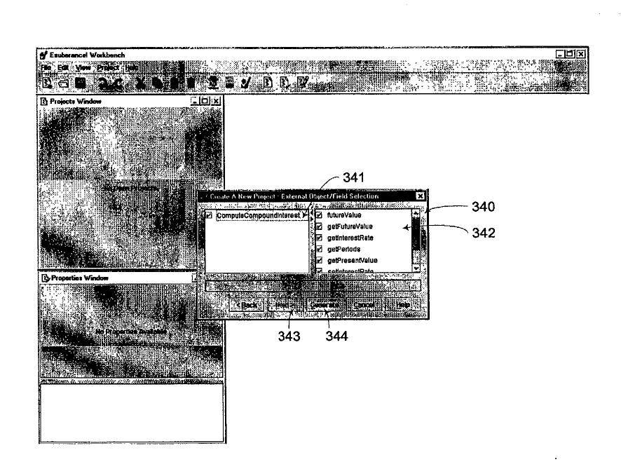

Once the Workbench has determined the protocol, it queries the external object to determine all its members, i.e., its methods and fields. The software developer is then given the opportunity to select which of these fields and methods the developer wishes included in the final application. Activation of the “next” button 324 causes the Field Selection Dialog Box to be displayed as seen in FIG. 6. The Field Selection Dialog Box allows the software developer to decide whether to include all fields or methods of the external objects just selected by means of External Object Connection Server Dialog Box or only some of these fields. In the left area of the Field Selection Dialog Box is a listing of the external objects just selected and the right area displays all available fields and methods associated with the external object selected in area 341. Both the objects and the fields can be marked for inclusion, or unmarked to be excluded from the Project by clicking on the external object or field.

If additional objects are to be included from other locations, other objects having different protocols are to be specified or if different user names or passwords are necessary with regard to certain of the objects, the software developer activates the “next” button of Field Selection Dialog Box and a new External Object Connection Server Dialog Box is displayed in which fields are selected by Field Selection Dialog Box 340 as above. This process is repeated until all additional objects, protocols, locations, user names or passwords have been designated, whereupon the software developer activates the “generate” button or 344.

When the software developer activates the “generate” button or 344, the Workbench generates the Project specification file or Base Project similar to that generated for a Project which does not interact with an external object. For Projects interacting with external objects, there are general references to the external object previously entered such as the server connection for each object, user ID, password, in the Project Specification File. For each method and field in a designated external object, the Workbench generates by reflection a list of attributes including its class name for inclusion in the Project specification file gathered from the external object.

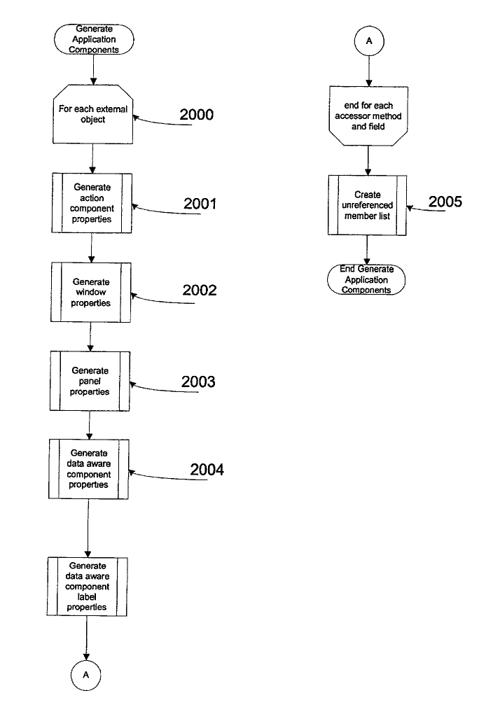

FIG. 7 is a flow diagram of the generation of the information about each external object for inclusion in the Default Project. The information will be sufficient for the creation of a window for each external object.

An action is a component which causes such a window to be displayed in the application. The Workbench generates the information about an appropriate action for each external object. The Workbench gives the action the same name as that which designates the external object and provides default parameters. That action may be attached to a tool bar, menu or button during the editing stage. The Workbench next generates the window's properties such as size, color, and font, using default values. It uses as the names of the window, the name of the external object and thus, the action. The Workbench thereby associates the window with the external objectWithin each window, one or more panels is generated. The panel is a connection between the external object window and the external object to which it relates and is connected to the external object upon building of the application by the Runtime. Each panel is associated with, i.e., connected to, only one external object. Multiple panels can be placed in a window. The Workbench, by querying the external objects, provides the information for such connection within the Default Project.

The Workbench then looks at each accessor method and field in the external object and generates the corresponding description for text fields, combo boxes and radio buttons for each using default values for each such panel type The nature of the panel depends on the nature of the accessor method or field. For example, The Workbench would produce descriptions of radio buttons or combo boxes for range bounded data, check boxes for set data, and text fields for data that is neither range bound nor set in nature. Text field sizes are set according to the kind of data that is expected and may be masked to further complement the data display and input. For each accessor method that is identified on the external object, a text field is generated the size of which is set according to the type of parameter or return object that is declared.

The Workbench develops a label for each text field, combo box and radio button. The text of the label corresponds to the name of the accessing method or field.

If, there are any members (method or data) that could not be associated with text fields, radio buttons, combo boxes, the Workbench creates for these members an unreferenced member list to aid the software developer. The software developer can use information contained on the unreferenced list to further extend the behavior of the project via programming code during editing. That is, the software developer can utilize the members from the unreferenced list to add additional functionality to the Built Project.

The Workbench has combined the information about the external object gained from reviewing each component and sub-component of the external object and combined this information with certain default properties in order to develop a complete description of an external object window allowing access and use of all selected components of the external object. Once a Project Specification File is completed, the Workbench generates a Project directory shown schematically in Fig. Into this directory, the Workbench loads the Project Specification File 334 and three empty sub-directories; one for image files 331, one for help files and one for programming code files If an application were to be generated using the information obtained in the Default Project, the Runtime would generate a frame or dialog for each object having a text field for each field and a text field for each accessor method. The frames would then be listed in Project Box 304.

Obviously while an application arising from such a default Project could be run, refinement of this default information gathered by the Workbench would in most cases create a far more useful application. From this point forward, the Workbench acts as editor of the information about the selected objects in order to refine the ultimate display of the interaction with the object.

Editing of the Project be accomplished either on a newly generated Default Project or by selecting and loading an existing Project. To select an existing Project, the software developer either from the file menuor from the folder icon on the tool bar opens an Existing Project Dialog Box As seen in Fig. an Existing Project Dialog Box contains a directory navigator from which the software developer selects a Project in the normal manner. The Workbench loads the selected Projects upon selection of the open button This process can be repeated to load several Projects.

Once a Project is opened using a dialog box hierarchical list is displayed in Window of the major components of the Project as seen in Fig. These would normally include for each project, external objects, windows, components, styles, and notes which were identified in generation of the Default Project. If multiple projects have been opened, each hierarchical list will be made visible by clicking on the appropriate Tab 401.

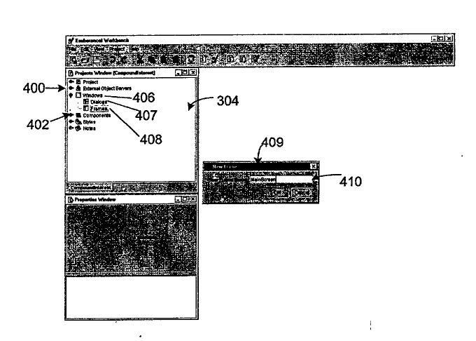

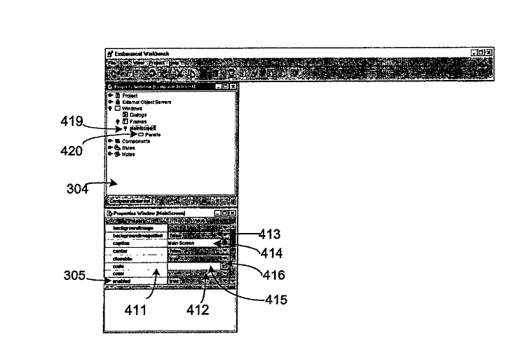

Each element of List may be opened to the next level by clicking on the appropriate icon Once an element to configure is selected, its pertinent parameters are displayed in property window These initial values were set during generation of the Default Project as discussed above. A new element is added at any level by right clicking on the listing on in window to which it will be a component. As seen in FIG. 11, for example, the top level Windows has been opened to show two sub-levels, Dialogs 407 and Frames 408. A new Frame 419 has been added and been titled through text field 410 in New Frame Dialog Box 409 generated by right clicking on Frames listing 409. As seen in FIG. 12, standard properties for the new frame are displayed in the properties window 305. List 411 itemizes various properties of the new item and 412 displays the values. Initial values are set automatically but may be modified either by drop down lists 413 or text fields 414. Lists 411 and 412 allow the new frame to be fully defined. They include such things for a frame as background image, tiling, the caption positioning, and the like. There is also a text field 415 for identifying a file of additional programming code to modify the behavior of the frame.

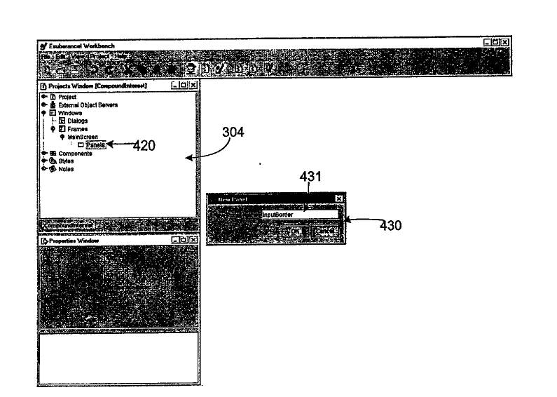

As seen in FIG. 13, after the general parameters of the appearance of the main screen 419 have been developed in the properties window 305, a panel is generated in a similar manner by right-clicking on the panels entry 420 in box 304, opening new panel identification box 430 with text field 431 for entry of the name of the panel. This in turn generates both the necessary component elements of the panels 431 and various sub-elements 432-434. Upon selection of any of these elements, an appropriate list of necessary elements having standard values is generated in the properties window 305. A help box may also appear 437. An edit window 500 is generated, which displays the panel 510 as it is original automatically generated and as it is modified during editing. The elements listed in the properties window 305 and in the edit window 500 are interactive. In other words, a change in box 305 will change the appearance of panel 510 and a change made directly on panel 510 will make a change in the values displayed in 305.

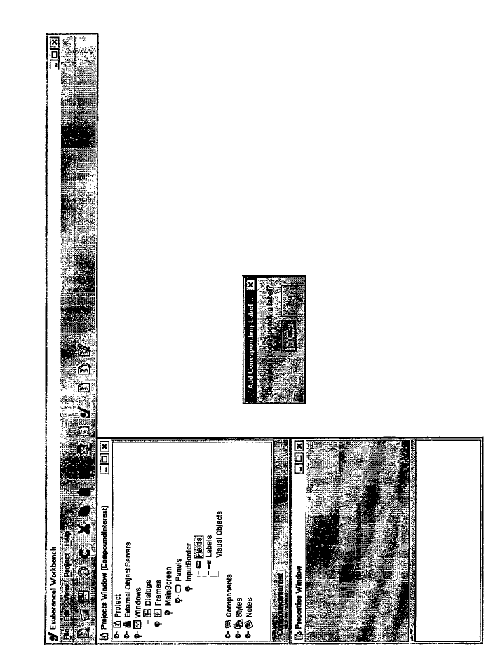

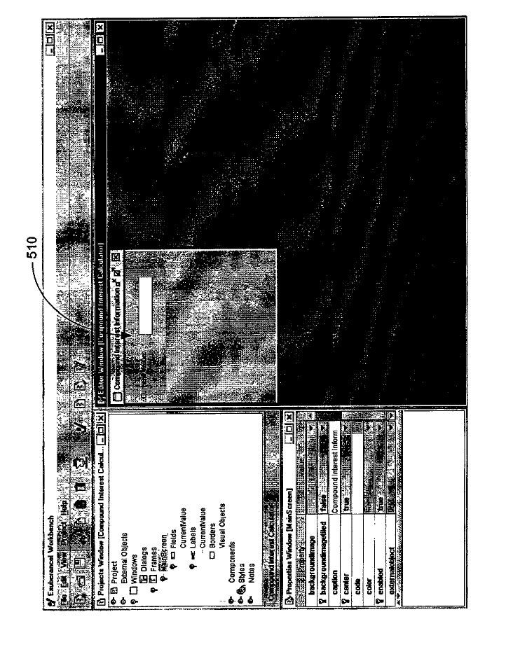

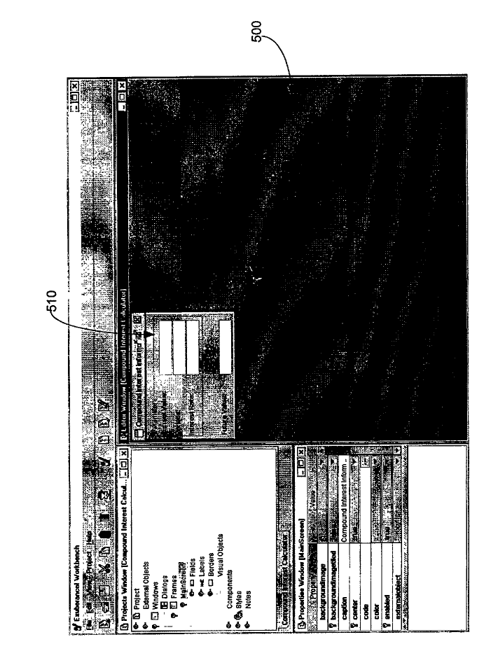

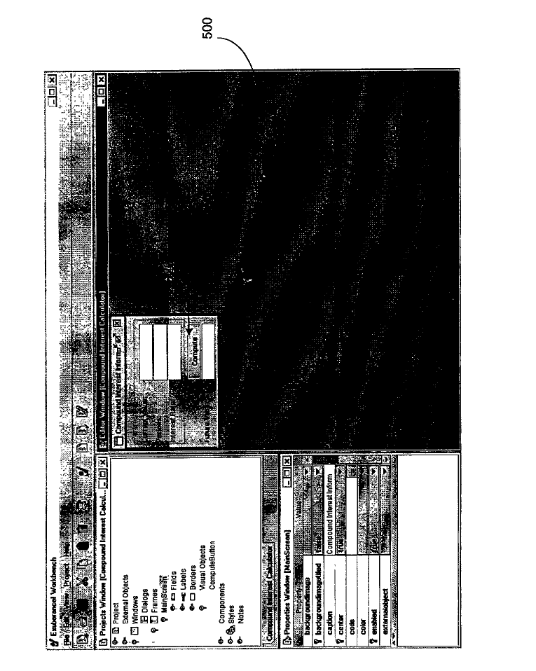

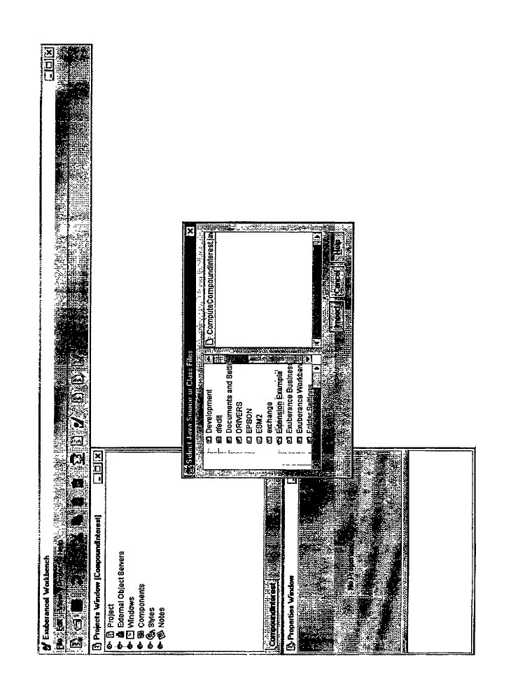

As most clearly seen in FIGS. 16, 17 and 18, in a similar manner labels and text fields can be generated to fully form the desired panel. Through repeated iterations box 510 will have all the necessary elements added to the panel as displayed in Window 500 shown in FIG. 18. If there is to be an interaction not automatically generated by the Workbench, a visual object may be defined and added to the panel 510. A new Visual Object Dialog Box 512 is displayed with a text field for naming the visual object as seen in FIG. 1 9. The properties of the visual object are defined by properties box 305. As seen in FIG. 20, a new button 520 is displayed in panel 510. As shown in FIGS. 21 & 22 this new button can be associated in a conventional manner with programming code to perform the desired function and saved at a location for later incorporation in the Built Project. Collections of programming code for use in the Built Project may be simply collected in a single directory or organized in subdirectories as desired by the software developer, for example, by subject matter.

After normal editing is completed, the project may be globalized 104. In this context globalization of the Project is the incorporation of alternate versions in different human languages into a single ProjectJAR. During globalization, the software developer provides one or more alternate entries grouped by language for each human language to be available in the Project. The Runtime determines the correct language, locale, and dialect from the settings on which the platform that the application runs. If a computer's default language is German and the Built Project has been globalized to include German, the application generated from the Built Project will be in German in a German format and respond to a German keyboard. Equally, the ability to substitute alternate elements and programming code within the Built Project allows the use of accessibility features for disabled users. Thus, for a blind user, the Built Project may allow ready substitution of sounds or Braille for the written word.

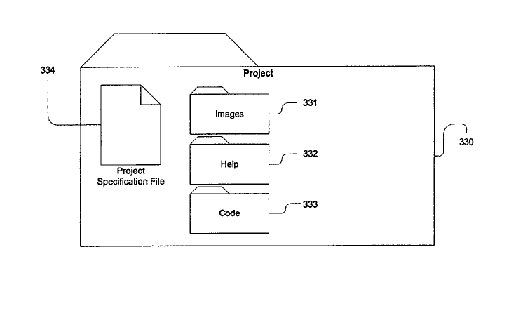

At this point the Project parameters primarily reside in the Project file as shown schematically in FIG. 8. As noted previously, the Project specification file 334 defines the Project through a list of properties and values in a compressed text file shown in uncompressed form in Fig. For example, the size of the font in a default label may be designated by its branch (style) and its sub-branches and properties (font, default label, size) as “style.font.DefaultLabel.size”560 with a value of “12”561. The project can be tested 106 in this format by selecting the appropriate menu item under the project menu 380, or by selecting icon 381 on the tool bar. This generates an application based on the Project in its present non final state and allows the software developer to test its operation. Help files for the project can then be generated in a conventional manner.

The project is now ready for building 108. The software developer indicates by selection of the build option on the project menu 380 or the appropriate build icon 389. A Build Project Dialog Box 600 is displayed which in text field 601 allows entry of the version number and in text field 602, the location where the Built Project is to at least temporarily reside. After entry of this information, building of the project can be commenced by activating “build” button 603.

The Workbench then proceeds to use the Project Specification File 334, the image files previously collected in the image directory 331 and the help files collected in help directory 332 to generate a Built Project directory. The Project Specification File 334 listings are converted to a Project Specification Object 385. The Project Specification Object 385 is organized into the equivalent of a structure of directories and subdirectories based on the various branches and sub-branches and values contained in the Project Specification File 334. By saving the information in the Project Specification File 334 as a Project Specification Object 385, the need for the Runtime to convert the compressed text file of the Project Specification File 334 with the corresponding loss of time is eliminated.

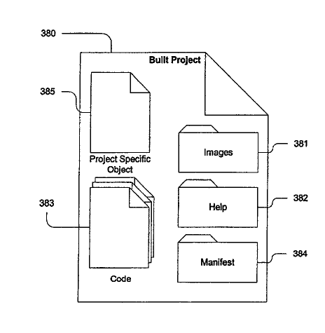

The image files that were contained in the project file directory 331 are stored in the Built Project Image Directory 381 shown schematically as FIG. 25. Similarly, the help files contained in the Project Directory 332 are stored in the Built Project Help Directory 382. The programming code files that may have been attached to one or more aspects of the project 383 may at this time also be stored in the Built Project Directory 382. The programming code files collected in the Built Project may be organized in the same fashion as it was organized and saved during generation. Finally, a manifest 384 is generated containing general information about the Built Project, such as identification of the software developer, version number, the starting instruction which begins the development of an application from the Built Project, an indication of additional JARs necessary to build the application and whether the JAR is locked such that the JAR may not be altered.

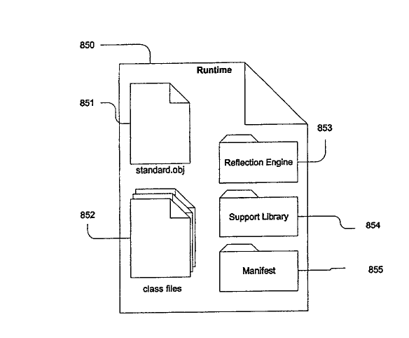

The resulting Built Project can be used with the Runtime to generate the desired application. The Built Project and the Runtime in combination build the application which then runs independently of the Runtime. The Runtime may be written in Java and contained in a JAR 850 shown schematically in FIG. 26. As such, it contains a standard.obj 851, Class files 852, Reflection Engine 853, a Support Library 854, and a Manifest 855. The Reflection Engine 853 is the heart of the Runtime. It provides the logic that is necessary to interpret the Built Projects contents, reflect upon the related environment and produce the user interface, and connect the user interface to the external objects that are specified. The Standard.obj 851 contains specifications that are common to many projects in a Serialized Specification Object similar in construction to that of the Project Specification Object 385 of a Built Project 380. The Support Library 854 is a collection of executable programming code that is used to assist the software developer by providing common development elements not part of the Reflection Engine. Many elements of the Support Library are coupled to standard.obj specifications. The Class Files 852 are executable files that are not part of the Reflection Engine or Support Library that assist the execution of the Project, such as files to assist in bootstrapping the Built Project 380. The Manifest contains information about the construction of the Runtime. Together they form a program to build an independent application based on the Built Project 380 using the JRE already residing on the computer.

The Runtime Reflection Engine 853 constructs the application from the Built Project, i.e., it constructs all of the objects that compose an application that is described in the Built Project. As noted above, when the Default Project is generated a description of each field and method is added to the project specification file 334 which upon finalization of the project becomes part of the Project Specification Object. The Reflection Engine first looks 1500 at the Project Specification Object 385 to determine each component underlying class designation. It then maps the construction features 1501 set forth in the Project Specification Object 385 for the component needed to be specified for that class to help the runtime properly reflect upon the target class. It uses information contained in the Built Project 380 including the target class, the methods that are expected, and a mapping of common method names to variants of those names. This step is necessary to resolve individual differences between the interfaces of commonly used classes. The Reflection Engine then constructs a visual object based on this information by using as a constructor the constructor specified in the Project Specification Object 385 or if none is specified, the default constructor for that particular Java class. The Reflection Engine then maps operation features 1503 for use in connection with the operators and then installs the post instantiation operators such as listeners to respond to events such as caused by clicking on a visual object.

Thus instead of the software developer having to know the specific constructor for the object to be generated, the Reflection Engine looks to the class of the object and thus the constructors available for such object and either selects one specified in the Project Specification Object, or selects the default constructor for that class. By use of the Reflection Engine, Built Projects may also easily be retargeted without the need to readdress the programming of the Built Project. This feature becomes important using the same application on devices that have widely varying capabilities. For example, a Built Project may be created for a full featured platform like a desktop but could then be deployed on a cellular telephone. The cellular telephone environment may have a significantly different set of environment classes.

In operation the Runtime first queries the user's computer as to standard settings, including language, physical location systems and the like to determine aspects of the completed application Thus, it may determine that the machine is located in Germany and uses the German language by a review of the existing computer files and accordingly would build the resulting application in German using language formatting of a keyboard appropriate to a German user. If for some reason the Runtime cannot determine the language setting of the user's computer or the Built Project was not designed to support the computer's default language, the Runtime will use the Built Project's default language.

The Runtime takes the information in the Built Project 380 and deserializes the Project Specification Object. The Runtime then determines if there is any programming code 383 to be used in connection with the application and if so loads and invokes any open methods1007. Open methods are methods that are defined by the Built Project initiated prior to the application becoming available to the user such as preparing a log file.

The Runtime is now ready to determine if the application will have the standard look and feel of the user's computer platform, or special look and feel features in the Built Project 380. If the look and feel is not specified by the Built Project, the resulting application assumes the computer platforms look and feel. If, however, the look and feel is specified, the runtime attempts to load the look and feel into the application. If, for some reason, the look and feel that is specified is unavailable (not present or not licensed to run on the target platform) the default look and feel for the user's computer platform will be used. At this point it may also see if there are any special accessibility features and if so, initiate such features 111.

The Runtime installs the Help 1012 and creates the desired application desktop based on the parameters supplied in the Built ProjectJAR 380 using the information in the Project Specification Object 380. The Runtime then connects the application so built to any external objects 1014, displays the specified splash screens 1015 and 1016 and displays any start window 1017 and 1018.

The result is an independent application which stands free of the Runtime. Thus, both the Default Project and the Built Project are in actuality abstractions of the application. That is they contain the abstract concepts delineating the desired application stored in the form of object that are related to one another. These objects and relationships are maintained in the Project Specification File and consequently the Project Specification Object 385 for Built Projects. The Runtime takes this abstraction and creates the application. The user in using this application does not in any way reference the Runtime or in fact interact with the Runtime after the application is built. Thus, for any given use of the application, communication with the Runtime has essentially ended after the application has been constructed.

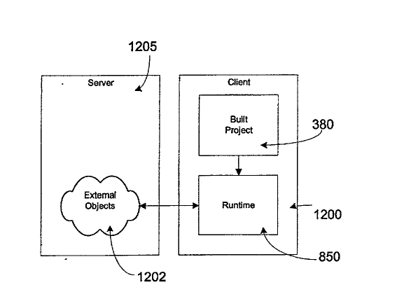

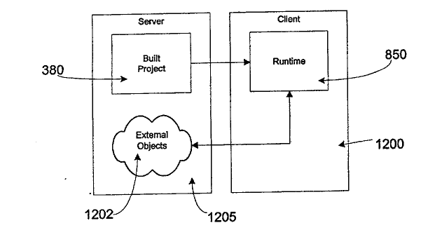

Given the nature of intranets and the Internet, the Built Project Runtime and external objects may reside on the same or different computers in such networks. For example, as shown schematically in FIG. 29 the Built Project 380 and the Runtime 850 may reside on the user'ss client computer 1200 while the external objects 1202 to which it interconnects may reside on the server 1205. Equally, the Runtime 850 may reside on the server 1205 with the external object, leaving only the Built Project 350 on the client 1200. Similarly, as shown in FIG. 31 the Built Project 380 and the external objects 1202 may reside on the server 1205 with only the Runtime 850 residing on the us's computer 1200. The simplest alternative is for all three, the Built Project 380, the Runtime 850 and the external object 1202 to reside on a single computer 1206. These alternative constructions are possible since both the JAR containing the Runtime 850 and the JAR containing the Built Project 380 are of relatively small size with the JRE already residing on the user's computers. Other combinations using middleware and relating to multiple external objects may lead to alternative configurations.

It is understood that the present embodiment described above is to be considered as illustrative and not restrictive. It will be obvious to those skilled in the art to make various changes, alterations and modifications to the invention described herein. To the extent that these variations, modifications and alterations depart from the scope and spirit of the appended claims, they are intended to be encompassed therein.

1. A method for creating an application which interacts with at least one external object, said method comprising the steps of:
learn from the object's interface information concerning the methods and fields contained in said external object by reflection;
combine the information obtained from the external object with selected default parameters sufficient to describe a visual displays for each accessor method and field in said external object;
store the description of the visual display; and
using such stored description, build a software application having such visual displays which interacts with said external object.

2. A method according to claim 1 wherein said description of the visual display is stored as a serialized object.

3. A method according to claim 1 wherein the resulting application will have a window which is connected to the external object.

4. A method according to claim 1 where the resulting application will interact with more than one external object and where each external object will have a separate window connected to it.

5. A method according to claim 1 where the resulting application will interact with more than one external object and were the resulting application will have at least one window which interacts with more than one external object.

6. A method according to claim 1 where said description of the visual display is edited prior to the building of the application.

7. A method according to claim 6 wherein in editing said description of the visual display, programming code is associated with elements in the description.

8. A method according to claim 7 wherein said programming code manipulates an external object.

9. A method according to claim 1 wherein the description of the visual object defines text fields and dialogs for interaction with the methods and fields of the external object.

10. A method according to claim 9 wherein the description of the visual object allows the use of labels for the text fields and dialogs in alternative human languages.

11. A method according to claim 9 wherein the description of the visual object provides for the use of accessability features for disabled users.

12. A method according to claim 1 wherein the description of the visual object is in a format which allows it to be used on multiple computer platforms.

13. A method for creating an application which interacts with at least one external interface, said method comprising the steps of:
learn from the external interface information concerning the methods and fields controlled by said external interface by reflection;
combine the information so obtained with selected default parameters sufficient to describe a visual displays for each accessor method and field controlled by said external interface;
store the description of the visual display; and
using such stored description, build a software application having such visual displays which interacts with said external object.

14. A method according to claim 13 wherein said description of the visual display is stored as a serialized object.

15. A method according to claim 13 wherein the resulting application will have a window which is connected to the external object.

16. A method according to claim 13 where the resulting application will interact with more than one external interface and where each external interface will have a separate window connected to it.

17. A method according to claim 13 where the resulting application will interact with more than one external object and were the resulting application will have at least one window which interacts with more than one external object.

18. A method according to claim 13 where said description of the visual display is edited prior to the building of the application.

19. A method according to claim 18 wherein in editing said description of the visual display, programming code is associated with elements in the description.

20. A method according to claim 19 wherein the programming code manipulates an external interface.

21. A method according to claim 13 wherein the description of the visual object defines text fields and dialogs for interaction with the methods and fields of the external interface.

22. A method according to claim 21 wherein the description of the visual object allows the use of labels for the text fields and dialogs in alternative human languages.

23. A method according to claim 21 wherein the description of the visual object allows for use of accessability features for disabled users.

24. A method according to claim 13 wherein the description of the visual object is in a format which allows it to be used on multiple computer platforms.

25. A method for creating a description of an application which interacts with at least one external object, said method comprising the steps of:
learn from the object's interface information concerning the methods and fields contained in said external object by reflection;
combine the information obtained from the external object with selected default parameters sufficient to describe a visual displays for each accessor method and field in said external object; and
store the descriptions of the visual display.

26. A method according to claim 25 wherein said description of the visual display is stored as a serialized object.

27. A method according to claim 25 wherein said description includes a description of a window to be connected to the external object.

28. A method according to claim 25 wherein said description includes a description of a window which can interact with two or more external objects.

29. A method according to claim 25 where said description of the visual display is edited.

30. A method according to claim 29 wherein in editing said description of the visual display, programming code is associated with elements in the description.

31. A method according to claim 30 wherein the programming code can manipulate an external object.

32. A method according to claim 29 wherein the description of the visual object defines text fields and dialogs for interaction with the methods and fields of the external object.

33. A method according to claim 32 wherein the description of the visual object allows the use of labels for the text fields and dialogs in alternative human languages.

34. A method according to claim 32 wherein the description of the visual object allows for use of accessability features for disabled users.

35. A method according to claim 32 wherein the description of the visual object is in a format which allows it to be used on multiple computer platforms.

36. A method for creating an application from a serialized description of the application which interacts with at least one external object, said method comprising the steps of:
using the stored description, build a software application having such visual displays which interact with said external object, which application operates independently of the software which creates the application.

37. A method according to claim 36 wherein said external object is contained on a computer other than the computer on which the application is built.

38. A method according to claim 36 wherein said external object is contained on a computer other than the computer on which the application is built.

39. A method according to claim 36 wherein said description is constructed on a computer other the where the external object resides.

40. A method according to claim 1 wherein said external object is contained on a computer other than the computer on which the application is built.

41. A method according to claim 1 wherein said external object is contained on a computer other than the computer on which the application is built.

42. A method according to claim 1 wherein said description is constructed on a computer other the where the external object resides.
